(19) United States
(12) Patent Application Publication
(10) Pub. No.: US 2012/0264024 A1
(43) Pub. Date: Oct. 18, 2012

(54) Methods and apparatuses for electrochemical cell system with movable medium and non-conducting substrate

(76) Inventor: Walter E. Pelton, San Jose, CA (US)

(21) Appl. No.: 13/480,471

(22) Filed: May 25, 2012

Related U.S. Application Data
(63) Continuation-in-part of application No. 13/006,031, filed on Jan. 13, 2011, now abandoned.
Application No. 13/006,031 is a continuation-in-part of application No. 11/489,274, filed on Jul. 18, 2006, now Pat. No. 7,892,681.
Application No. 11/489,274 is a continuation of application No. 13/169,637, filed on Jun. 27, 2011.
Application No. 13/169,637 is a continuation-in-part of application No. 11/539,820, filed on Oct. 9, 2006, now Pat. No. 8,005,883.
Application No. 11/539,820 is a continuation of application No. 10/822,314, filed on Apr. 12, 2004, now Pat. No. 7,120,659.
Application No. 10/822,314 is a continuation of application No. 09/560,221, filed on Apr. 28, 2000, now Pat. No. 6,735,610.
(60) Provisional application No. 60/700,954, filed on Jul. 19, 2005.
(60) Provisional application No. 60/131,656, filed on Apr. 29, 1999.
(60) Provisional application No. 60/131,661, filed on Apr. 29, 1999.
(60) Provisional application No. 60/131,667, filed on Apr. 29, 1999.
(60) Provisional application No. 60/131,825, filed on Apr. 29, 1999.
(60) Provisional application No. 60/131,858, filed on Apr. 29, 1999.
(60) Provisional application No. 60/185,346, filed on Feb. 26, 2000.

(51) Int. Cl. H01M 4/86; H01M 8/16; H01M 8/04

(52) U.S. Cl. 429/401; 429/513; 429/523

(57) ABSTRACT

The present invention provides methods and apparatuses for half-cells to oxidize protons in electrochemical half-cells with no medium and to oxidize acid-hosted protons in half-cell systems with a medium in a non-conducting substrate having openings and an apparatus to transfer the media among openings. Details are described of technology to capture protons into acid media so as to provide hosted protons. Detectors are described that can provide seismic and weather-related data. A method of producing power from in vivo vital fluids is given.

### CROSS-REFERENCE TO RELATED APPLICATIONS

This application claims benefit of U.S. Provisional Patent Application No. 61/489,258, filed May 24, 2011, and is also a continuation in part of U.S. patent application Ser. No. 13/006,03, filed Jan. 13, 2011, entitled “Methods and apparatuses for distributed fuel cells with nanotechnology” which has been renamed to “Electrochemical Half-cell System Having a Movable Non-Conducting Substrate” and was allowed on Feb. 2, 2012, which is a continuation in part of U.S. patent application Ser. No. 11/489,274 filed Jul. 18, 2006, entitled “Methods and apparatuses for distributed fuel cells with microelectronic structures” now U.S. Pat. No. 7,892,681; and claims benefit of U.S. Provisional Application No. 60/700,954 entitled “Methods and apparatuses for distributed fuel cells with transistor system” filed Jul. 19, 2005, also U.S. patent application Ser. No. 13/006,115 (now abandoned), filed Jan. 13, 2011, entitled “Methods and apparatuses for distributed fuel cells with transistor system” is a co-pending application of U.S. patent application Ser. No. 13/006,031, all of which are incorporated by reference in their entirety except where inconsistent with the present application. This application is also a continuation of U.S. application Ser. No. 13/169,637 filed Jun. 27, 2011, which is a continuation in part of U.S. application Ser. No. 11/539,820 issued as U.S. Pat. No. 8,005,883 B2 on Aug. 23, 2011 filed Oct. 9, 2006 which is a continuation of U.S. application Ser. No. 10/822,314, issued as U.S. Pat. No. 7,120,659 B2 on Aug. 23, 2011, filed Apr. 12, 2004, which is a continuation of U.S. patent application Ser. No. 09/560,221, filed Apr. 28, 2000, issued as U.S. Pat. No. 6,735,610 on May 11, 2004, each of which is hereby incorporated herein in its entirety by reference, and which claims priority from the following U.S. Provisional patent applications, the contents of each of which are incorporated herein by reference: U.S. Provisional patent application Ser. No. 60/131,656, filed on Apr. 29, 1999, entitled EXPLOITING REDUNDANT VALUES TO PERMIT USE OF PRE CALCULATIONS; Ser. No. 60/131,661, filed on Apr. 29, 1999, entitled: NOVEL PARADIGM FOR EVALUATING FOURIER COEFFICIENTS; Ser. No. 60/131,667, filed on Apr. 29, 1999, entitled SECOND NOVEL PROCESSING CIRCUIT; Ser. No. 60/131,825 entitled FIRST NOVEL PROCESSING CIRCUIT, Ser. No. 60/131,858, filed on Apr. 29, 1999, entitled: USING GATING WITH THE VALUE SORTING METHOD and U.S. Provisional patent application Ser. No. 60/185,346 entitled: METHODS AND APPARATUS FOR PROCESSING AND ANALYZING INFORMATION, filed on Feb. 26, 2000.

### BACKGROUND

An electrochemical cell is an example of a bias source that may have millimeter or nanometer dimensions. An electrochemical cell includes two half-cells, each of which includes an electrode and a reagent. The reagent in one half-cell undergoes an oxidation reaction at the anode, producing electrons as one reaction product. The reagent in the other half-cell undergoes a reduction reaction at the cathode, consuming electrons as a reactant. Ionic balance between the two half-cells is maintained by an ion-conducting interface between the half-cells. The electron flow from the anode to the cathode will provide an electrical current to an electrical load connected to the two electrodes.

In order for complementary half-cell reactions to take place in an electrochemical cell, ions must travel between the two electrodes. In a conventional electrochemical fuel cell, an ion conducting interface is present between the electrodes. The interface prevents bulk mixing of the reductant and oxidant, but permits ions to flow between the two electrodes. Examples of ion conducting interfaces include a salt bridge and a polymer electrolyte membrane.

The reagent in the half-cell containing the cathode is an oxidant, since it undergoes a reduction reaction at the cathode. The reagent in the half-cell containing the anode is a reductant, since it undergoes an oxidation reaction at the anode. The electrons produced at the anode can travel through an external circuit to the cathode, where electrons react with the oxidant at the cathode catalyst to produce a reduced product. When the electrochemical cell is a fuel cell, the reductant is a fuel.

Hydrogen, methanol and formic acid have emerged as important fuels for fuel cells, particularly in mobile power and transportation applications. The electrochemical half reactions for a hydrogen fuel cell are listed below.

| | | | |
|---|---|---|---|
| Anode: | 2H₂ | → | 4 H⁺ + 4 e⁻ |
| Cathode: | O₂ + 4 H⁺ + 4 e⁻ | → | 2 H₂O. |
| Cell Reaction: | 2H₂ + O₂ | → | 2 H₂O |

To avoid storage and transportation of hydrogen gas, the hydrogen can be produced by reformation of conventional hydrocarbon fuels. In contrast, direct liquid fuel cells (DLFCs) utilize liquid fuel directly, and do not require a preliminary reformation step of the fuel. As an example, the electrochemical half reactions for a Direct Methanol Fuel Cell (DMFC) in acidic conditions are listed below.

| | | | |
|---|---|---|---|
| Anode: | CH₃OH + H₂O | → | CO₂ + 6H⁺ + 6e⁻ |
| Cathode: | 1.5 O₂ + 6 H⁺ + 6 e⁻ | → | 3H₂O. |
| Cell Reaction: | CH₃OH + 1.5 O₂ | → | CO₂ + 2H₂O |

As another example of a DLFC, the electrochemical half reactions for a Formic Acid Fuel Cell (FAFC) in acidic conditions are listed below.

| | | | |
|---|---|---|---|
| Anode: | HC(═O)OH | → | CO₂ + 2H⁺ + 2e⁻ |
| Cathode: | O2 + 2 H⁺ + 2e⁻ | → | 2H₂O. |
| Cell Reaction: | HC(═O)OH + O2 | → | CO₂ + 2H₂O |

Several types of fuel cells have been constructed, including polymer electrolyte membrane fuel cells, direct methanol fuel cells, alkaline fuel cells, phosphoric acid fuel cells, molten carbonate fuel cells, and solid oxide fuel cells. For a comparison of several fuel cell technologies, see Los Alamos National Laboratory monograph LA-UR-99-3231 entitled Fuel Cells: Green Power by Sharon Thomas and Marcia Zalbowitz.

### SUMMARY

In one aspect, the invention is an electronic device, comprising an ability to sense and electrically respond to the presence of free protons.

In another aspect, the invention provides a method to produce a field of free protons.

In another aspect, the invention provides a power generating cell that can produce power from materials present in a living organism.

In yet another aspect, the invention provides a free proton field that can be used to research its effects.

In yet another aspect, the invention provides a free proton field that can be used by a living organism to promote energy and sustain normal life activities with less food consumption.

The following definitions are included to provide a clear and consistent understanding of the specification and claims.

The term “electronic device” is a device that includes an electrical circuit. Electronic devices include, for example, microprocessors, application-specific integrated circuits (ASICs), memory chips, analog integrated circuits, computers, mobile phones, airplanes or automobiles.

The term “bias source” is an element that increases or decreases the electrical potential applied to a system. Examples include fuel cells, batteries and power supplies.

The term “complementary electrode” refers to an electrode that completes the requirements for functionality. In a half cell it will act as an electrical connection to the electrolyte and has no half-cell equation.

The term “catalytic electrode” refers to an electrode which carries out a required half-cell reaction which it catalytically facilitates.

The term “membrane” encompasses a material between two half-cells forming part of the current path and which has properties that differ from those of the half-cell reactants. Such properties generally include being solid rather than liquid plus other properties that may be optimized in the construction of a cell. This term is usually limited to a continuous chemical substance.

The term “electron-aura” refers to a field of free electrons.

The term “neutron-aura” refers to a field of free neutrons.

The term “proton-aura” refers to a field of free protons.

The term “electrode” is intended to mean the combination of the conductive contact and the anode catalyst (as required) or the conductive contact and the cathode catalyst (as required), respectively.

The term “semiconductor device” is intended to mean any type of device based on monolithic or solid state elements that includes, but is not limited to logic devices, digital devices, sensor devices, temperature devices, or the like.

The term “gated electrochemical cell” refers to a chemical fuel cell wherein ions can be influenced by a voltage or a bias from a gate electrode.

The term “half-cell” refers to an electrochemical cell having only one electrode equation wherein an active process occurs. If a second electrode is present it provides an electrical return path.

### ADDITIONAL BACKGROUND INFORMATION

Some details from other disciplines that should complete the understanding of the information presented herein are provided below. It is also important to discuss properties of nano-structures and develop a context for some relationships. This will also develop a view of protonized acid solutions and cases where surplus protons are present.

The properties of pure water do not make it very accommodating to having surplus protons added to it. Protons can temporarily ride on an H₂O molecule forming hydronium but little energy is associated with the combination and the site does not constitute a real residence. The unstable protons pass from water molecule to water molecule and diffuse quite rapidly. As the protons diffuse they repel each other electrically and remain distant. Electrons, protons and neutrons are not really able to exist in free and stable forms within most systems of matter other than high-temperature plasmas such as stars. Each of these, however do exist in meta-stable forms and it is important to understand their properties and effects. Free electrons may take the form of OH⁻ ions in an aqueous system. An exception is when they may exist as quasi-gases in a meta-stable state permeating other matter of whatever form. Protons and neutrons are similarly able to form quasi-gases in some environments differently than electrons. These transient plasma-gas structures will be referred to as “electron-aura”, “proton-aura” or “neutron-aura” according to what particle forms the meta-stable quasi-gas. This term will not be applied to neutrinos (which are not particles) or energetic particles (commonly referred to as rays). Proton-auras can contribute protons to acid solutions that are exposed to them.

It is important to realize that free protons in a solution may behave differently than classical ions. To understand the concept, consider a 5 Molar solution of sulfuric acid at a temperature of 20 degrees Centigrade. It has a pH that represents the degree of ionization of the acid in the water. It can be protonized by extra protons joining cores of SO₄⁻² in a locally-stable state. Instead of (2H⁺+SO₄⁻²) there will be (3H⁺+SO₄⁻²+e⁻) groups. Although this has additional protons the pH measure will not change proportionally. This can be explained as a population of “molecules” of (H⁺+e⁻) or as a “sea of electrons” forming to maintain electrostatic neutrality, but as will be discussed later there are many details that work together in this system.

Water at standard temperature-pressure (STP) is a liquid. Using the Avogadro constant of 6.02214199×10²³ molecules per mole and the weight of a mole of water, which is 18 grams; there are 3.3456×10²⁵ molecules per liter. The dissociation coefficient for water at STP is such as to give 10⁷ molecules of hydronium (H₃O⁺) per liter and 10⁷ molecules of hydroxide (OH⁻) per liter. To provide perspective, this is about 1 ionized molecule per 10¹⁸ molecules (and varies monotonically as a function of temperature). The fraction of carriers determines the bulk conductivity of pure de-ionized water, which is in the range of 20 M-Ohm-centimeters. Pure water is a liquid-state semiconductor and ice is a solid-state semiconductor in certain cases.

Hydronium is also referred to as (these are not identities):
1) H⁺
2) a proton
3) a protonized water molecule
4) a hydrogen ion
5) dissociated hydrogen

Hydroxide is also referred to as (these are not identities):
1) e⁻
2) an electron
3) a conduction band electron
4) a negative carrier
5) OH⁻

A proton is technically an ionized dissociated hydrogen atom. There is a very important special property of a single proton. When it is not paired in a molecule it does not resemble hydrogen in several ways. Hydrogen molecules (H₂) form a large percentage of the general mass of the universe. These behave in ways that are easy to identify. Nascent protons and unassociated electrons are another portion of the universe and cannot easily combine to form H₂ these have no spectral properties and may be referred to as dark matter. Deep within a star there are protons and electrons but their chemical bonding properties are minor above 3×10⁴ degrees centigrade. Toward the outer layers the temperature decreases and the low energy configuration H₂ becomes favored. Hydrogen is a reasonably common material in the solar system. Its mass is such that it will often be somewhat captive in a solar system and can be captured by planets or the star.

During certain solar eruptions there are masses of inner solar matter discharged at high velocities which cool quickly. These contain unassociated electrons and protons. In outer space conditions, there are few opportunities for these to become H₂ molecules. Those that reach earth have some opportunities to become parts of various chemicals. A variety of molecules are able to capture a proton and the results include effects on communication and living matter.

It is instructive to list some properties of hydrogen and water. The ionization energy of the electron in hydrogen is 2.5 electron-volts (the highest). The ground state of hydrogen is a pair of protons with two electrons revolving in orbits of 0.3 Å (Angstrom unit) diameter (the smallest of atoms). A molecule of H₂ has an H—H bond length of 0.746 Å (the shortest of nuclei) whereas a molecule of H₂O is an oxygen atom with two hydrogen atoms at an angle of 104.45° with each of the H—O bond lengths being 0.945 Å (the second shortest of nuclei). When a bond length is shorter the energy is greater. It is worth noting that each of these is an extreme case. These extreme energies partially result from electron spin-coupling and a complete understanding includes more details which are not part of this specification.

An astronaut observed medium-energy protons over regions where seismic events had recently occurred or were imminent. This was at first viewed along with palm-reading but it was confirmed by additional satellite observations and further programs were developed to augment the information. A 2006 article then added: “other precursors of major earthquakes—the concentration of radon, an inert gas, near the epicenter; the concentration of electrons in the ionosphere above the epicenter; and the content of crust-emitted metal-rich aerosols in the air, leading to an abnormally strong electric field there—”. It was noteworthy that they considered that the precursors included a concentration of electrons in the ionosphere (which is conductive) as that supports a mass of positive charge below (such as radon or protons) and an abnormally strong electric field (as would represent a collection of electrons above and a collection of positive charges (such as radon or protons) below).

An article on the internet, written in Bulgarian and referenced May 5, 2011, included the statement: “Seven hours before the first tremors in Japan, scientists discovered similar anomalies over the site of the forthcoming disaster. At that time Russian experts did not know what to do with this information.” Although none of these are research papers and are not submitted as scientific fact they are presented to enrich the context for the reader.

A scientific study of a local population of the species bufo bufo was in progress just outside L′Aquila, Italy when an unusual behavior was documented. The population of bufo bufo were reported by lead author Dr. Rachel Grant of The Open University, to exhibit the behavior over a period of five days preceding an earthquake (magnitude 6.3) and until five days after its last significant (magnitude>4.5) aftershock. The males appeared to lose interest in mating even though the peak of their mating cycle was imminent. They became preoccupied with “flight mode” as was reported in her paper published in the Zoological Society of London's “Journal of Zoology”. The researchers were unaware that an earthquake (Apr. 9, 2009 L'Aquila, Italy) would happen five days after the onset of the unexpected behavior but recorded their findings. Among the conjectures offered to explain the sudden exodus the authors listed “gases and charged particles”. Charged particles would include radon or proton “gases” that have been anecdotally claimed to accompany earthquakes. A lead time of five days was calculated, which is longer than current earthquake detectors such as seismographs which tend to be slightly after the fact. Although the behavior has only been documented to apply to male bufo bufo that are preparing to mate, further studies may substantiate responses under other conditions such as solar eruptions.

A fuel cell anode, using water as the electrolyte, that dissociates a fuel and releases protons has high impedance when the water is pure. When sulfuric or phosphoric acid is added, the water will dissociate one of the hydrogen atoms from the H₂SO₄ or H₃PO₄ leaving a core of (HSO₄⁻) or (H₂PO₄⁻) with an associated hydronium ion (H₃O⁺). These are far better receptors for protons than pure water and provide quasi-stable sites which allow the fluid to accept a quantity of protons while a number of electrons fill the fluid with OH⁻ (hydroxide ions). This then provides a low impedance system and protons are accommodated and conducted or diffused more easily. This environment does not actually oxidize the proton to form a neutral chemical but behaves as a transport medium.

Another type of site that is able to accommodate protons is ammonia (NH₃) which is converted to (NH₄⁺) by adding a proton. This form is reasonably stable especially in the presence of an amount of water wherein there is mobility for OH⁻ ions to retain electrical balance.

In a typical acid-electrolyte fuel cell or lead-acid cell there is a concentration of sulfuric or phosphoric acid ions in water (between 0.5 and 5 molar). The presence of acid cores will allow protons to be conducted by the solution with a corresponding number of electrons being drawn externally to balance the electrostatic equation. Without the acid, the same equations apply, but the electrolyte has a far lower acceptance of protons (and hence a higher impedance).

### BRIEF DESCRIPTION OF THE DRAWINGS

FIG. 1 is a simplified illustration of a proton-aura detector that is optionally directional.

FIG. 2 is a simplified illustration of an energy scavenging system implanted in a host.

FIG. 3 is a simplified illustration of a proton-aura detector with field enhancement.

FIG. 4 is a simplified drawing of a proton-aura generating system.

FIG. 5 is a simplified drawing of generating power from an animal.

FIG. 6 is a simplified drawing of a sensor predicting an earthquake.

FIG. 7 is a simplified drawing of a direct proton capture to form hydrogen.

FIG. 8 is a simplified drawing of a direct proton capture to form water.

FIG. 9 is a simplified drawing of a generalized system encompassing various media.

### CONTEXT OF THE INVENTION

Free protons pass through some materials (such as air), are blocked by others (such as sapphire) and adhere to the surface of others but cannot penetrate them (such as silica and carbon in forms such as graphene, carbon nanotubes and graphite). It is possible to identify those surfaces that host protons by the fact that they have an affinity to water and certain acids. Protons do not simply rip an electron off of the first atom they pass. This is not purely a matter of politeness. A proton requires the proper configuration around the electron before it can be captured and this isn't easily achieved. It may alternatively be in a special configuration before it can acquire an electron. This is a result of the proton being in moderate proximity to many electrons and it is attracted to all of them, which causes a general distribution of its force. The electrostatic force is omni-directional, it cannot merely attract one electron and ignore others unless that electron is extremely close (in which case it can acquire the electron and emit a photon). The result is that the free proton is more than free and is in effect exiled until it can find a site in which it can achieve a degree of stability or enter into a stable chemical bond. This imposes a meta-stability on the free protons and it is possible to distinguish them as a distinct form of matter. Just as diamond and graphite are distinct but related, free protons in a dense environment form a distinct type of plasma. It is not easy to fill a jar with pure protons because of their electrostatic properties, and they may exist as a lighter-than-hydrogen gas under certain conditions such as in a metalized Mylar balloon or a standard metal pressure tank, but they represent a high-energy form of ionized hydrogen (2.5 electron volts) and can capture an electron powerfully under some circumstances. Furthermore they can diffuse through many materials. They can draw electrons to the surface of conductors without combining. In the pure state, protons tend to diffuse through plastic materials that are hydrophobic, low density and high dielectric strength. High-density nonconductors such as sapphire are less easily diffused and materials with a conduction band tend to form a surface layer which results in a barrier.

Another case is that protons can be dispersed through some media intermixed with electrons and not react. One such case is low-density plasmas such as occur in deep space. This is stable as an equal mixture at low temperatures (below about 3000 degrees Fahrenheit). When large clouds of hydrogen, protons and electrons collapse under gravitational forces, they will ignite as the protons begin to form atoms of hydrogen. As hydrogen atoms collide with hydrogen atoms, the protons and electrons will each spin-couple and form hydrogen molecules, which may then raise the temperature to around 30,000 degrees Fahrenheit depending on the amount of hydrogen already present in the mix.

One more case is an aqueous solution of host molecules such as H₂SO₄ or H₃PO₄ which are conductive and can form a quasi-stable ion with a proton. Such a medium can host a large amount of ionic protons and a sea of electrons. In this case, a mole of either H₂SO₄ or H₃PO₄ (weighs 98 AU) and a mole of H₂O (18 AU) with a formula weight of 116 AU can accept one mole of protons (1 AU) and one mole of electrons (0 AU) raising the ionic formula weight to 117 AU. This represents 96,500 Coulombs each of electrons and protons when reacted in a half-cell.

If one proton collides with another proton in plasma and two electrons are packed close to them with low kenetic energy, the protons and the electrons will each spin couple and there will be a hydrogen molecule plus an energy release in the form of a photon, heat and/or electrical power. The limiting factor is that forcing two mutually repelling protons and two mutually repelling electrons into that configuration requires special conditions. To transition the protons and electrons into a low-energy configuration there must be an environment that facilitates the process. As with the deep space plasma, if the environment is a high-temperature plasma such as within the sun wherein a predominantly hydrogen/proton/electron atmosphere is at a thermal energy at which the proton electrostatic repulsion is a small factor and the thermal gradients allow the protons to become bound in pairs as they move to the lower temperatures near the surface. This occurs naturally as a result of the fact that H₂ is a far lower energy state than (H⁺+H⁺+e⁻+e⁻).

Solar temperatures are great promoters but there are cases such as on earth where such temperatures defeat design goals such as efficiency and portability. It is then valuable to create a situation where a proton can react in a controlled manner and release the energy as a voltage rather than as a photon or a temperature. An oxygen atom attached to a conductive catalyst can provide the right setting to capture a proton that is attached to an acid core such as (HSO₄)⁻. This happens regularly, such as a gold surface with oxygen molecules dissociated on the surface and the gold electrically connected to an external circuit. If a proton-bearing acid core strikes the oxygen atom and an electron is nearby (from the gold conduction band), an OH will be formed and remain on the surface. If a second proton-bearing acid core strikes the OH and another electron is available from the gold conduction band, a molecule of H₂O will result and two protons have moved from (H⁺+H⁺+O+O+e⁻+e⁻) into an ordinary chemical form (water) which is an example that is a common electrode reaction in a fuel cell (O₂+4H⁺+4e⁻ [symbol] 2H₂O). A second example is found in the charging of a lead-acid cell (2PbSO₄+4H⁺+4e⁻ [symbol] 2Pb+2H₂SO₄) and a third example is found in the discharging of a lead-acid cell (O₂+4H⁺+4e⁻ [symbol] 2H₂O). These are standard half-cell reactions and well-known.

In the case of a proton-aura the protons seek sites wherein an energy release tends to provide some stability. These can be found in certain structures such as living organisms which have a diverse variety of chemicals, metabolic processes and many sites of various types, some of which accommodate protons. Living organisms have processes that involve the release and capture of free protons.

When protons are released by mechanical processes such as diastrophism and the source is stress failure of granites and materials of the crust or mantle on either side of the Moho (Mohorovi\check{c}ić discontinuity), the protons will initially repel each other and spread. Those that move upward tend to reach the surface and produce a positive field in the atmosphere.

This specification interprets the behavior of the bufo bufo to be caused by a proton-aura, producing a change in the concentration of environmental protons, which then acted to turn their thoughts from “mating mode” to “flight mode”.

An Example of a Proton Oxidation Cell with Movable Medium

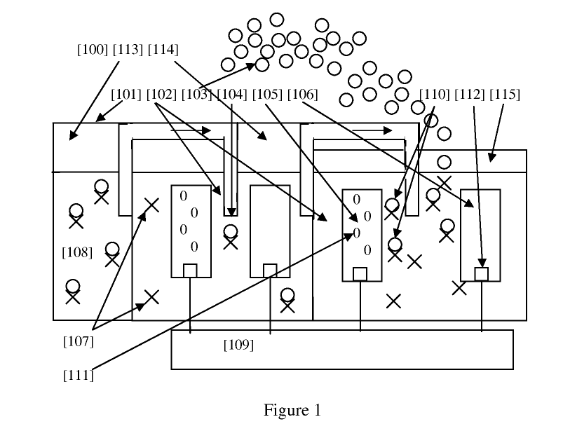

FIG. 1 is a simplified illustration of an electrochemical half-cell system with a non-conducting substrate that is driven by protons from a medium or by environmental protons [100]. It shows non-conductive half-cell substrate [101] comprising proton-hosting medium [102], proton-aura [103], medium exchange nozzle [104], catalytic electrode with external electrical contact [105], complementary electrode with external electrical contact [106], acid cores with proton-hosting sites [107], proton-hosting medium with protons [108], external electrical circuit [109], ion-hosting sites hosting protons [110], an oxygen molecule dissociated on the catalytic electrode [111], enclosed openings [113], [114], and exposed opening [115].

The half-cell [101] can provide power through the external electrical contacts of electrodes [105] and [106], when replete with an ion-hosting medium [102] with ion-hosting sites that contain protons [110]. When the hosted protons are supplied through the medium exchange nozzle [104], the oxygen supply is atmospheric (not shown). The oxygen molecules (not shown) are dissociated by the catalytic surface [105] and protons hosted by the acid cores [110]chemically react during collisions with oxygen atoms [111], forming water (not shown) and producing a current flow of one electron from the catalyst for each proton and a voltage equal to the difference between the binding energy of the acid core and that of water. As protons [110] are removed from the medium, electrons (not shown) move to the complementary electrode [106], through the external circuit [109] and back to the catalyst thereby delivering power to the circuit. The complementary electrode [106] is only able to conduct electrons between the external electrical contact and the medium, it has no electrode equation but is an ohmic contact. All of the energy is produced at the catalytic electrode [105]. As the hosted protons [110], become depleted, high-energy medium [108] is moved from covered supply opening [112] to covered opening [113] through nozzle to provide a continuing supply of protons.

### A Example of Oxidizing Environmental Free Protons

When used without having the high-energy medium injected the half-cell will only produce output when environmental protons arrive at exposed opening [115] from the environmental proton-aura [103]. As protons are exposed to the ion-hosting sites in the solution they are captured and they diffuse until they collide with an oxygen atom on the catalytic surface and produce water. This arrangement may be used as a proton-aura detector and can detect the presence of protons qualitatively or may be calibrated to detect protons quantitatively.

When the electrolyte solution contains acid cores and no available protons, the electrode reaction is not driven and the half-cell will not produce power. An important case is where the half-cell system [100] is able to receive protons [110] from an environmental source [103] such that the electrolyte [102] is exposed to an environmental proton-aura [103] derived from geological protons [103] or solar protons. The half-cell system [100] may be enclosed in a manner that is permeable to protons and the electrode will provide an output through an external circuit [109], returning through complementary electrode [106].

The hosted protons [110] will reach the catalytic electrode [105] in the presence of oxygen [111] and cause current to flow in an external electrical circuit [109] and produce a potential with respect to a complementary electrode. Environmental protons [103] reach the electrolyte [102] and are captured by acid cores [112] such as (HSO₄)⁻ or (H₂PO₄)⁻. The acid cores become intermediate sites for the protons [112] and they diffuse or conduct through the electrolyte [102] (actually the principal mode of transport is by acid cores colliding under thermal agitation and transferring a proton from one core to another) until they collide with an oxygen atom [111] in dissociated form on the conducting surface of the catalytic electrode [105] and complete the electrode reaction. This will produce a potential and/or a current that will reach the external circuit [109] to provide an indication of the presence of the protons [110]. Also the system may be used as a power source. The power may be used by a circuit [109] to store a digital representation of the potential as a function of time and periodically transmit the information.

There are other cases where a proton aura can be harvested to yield data or to provide energy. One case is near a volcano where the supply of protons is elevated continuously over an extended period. Another case is around crops such as a corn field where the protons will rise and fall daily as the crops move through cycles of photosynthesis and metabolic processes in the darkness.

### Example of In Vivo Half-Cell in a Living Organism

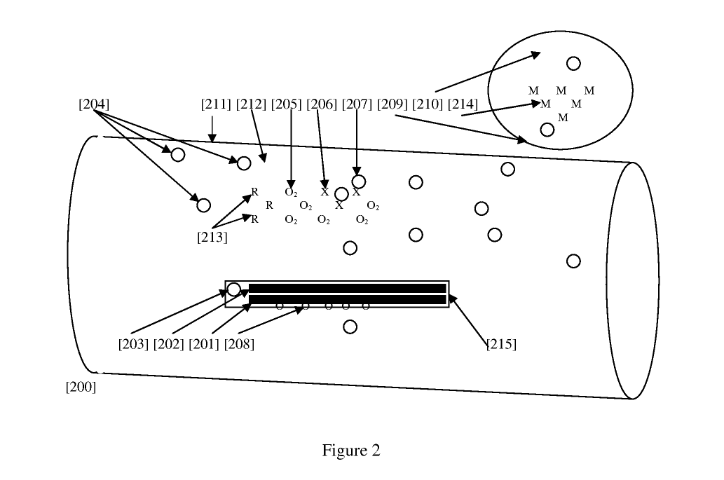

FIG. 2 is a simplified illustration of an energy scavenging system [200] implanted in a host. In vivo system [200] is an implantable system comprising a catalytic electrode [201], a complementary electrode [202], a circuit [203], free protons [204], oxygen [205], acid cores [206], protons residing on acid cores [207], oxygen atoms adhering to the catalyst in dissociated form [208], host cell [209], host cell cytoplasm [210], blood vessel [211], vital fluid (blood) [212] blood cells [213] and mitochondrion [214], scavenging implant [215] wherein the medium is moved by circulation within the organism.

An animal host cell [209], other than a red blood cell has mitochondria and performs the Krebs cycle. It contains host cell cytoplasm [210] that processes fats (not shown) and carbohydrates (not shown) to produce pyruvic acid (not shown). In the host cell cytoplasm [210], adenosine 5′-triphosphate (ATP) (not shown) molecules are phosphorylated by nicotinamide adenine dinucleotide (NAD) (not shown) providing energy to split one glucose molecule (not shown) into two pyruvic acid molecules (not shown). The NAD (not shown) is then reduced to nicotinamide adenine dinucleotide hydride (NADH) (not shown). This process produces free protons [204]. The molecules of pyruvic acid (not shown) then enter the mitochondrion [214] from the host cell cytoplasm [210] and are used to produce ATP (not shown) in the Krebs cycle. Many of the free protons [204] are captured by local acid cores [206] or other sites although some simply diffuse outward and become a proton-aura.

Some of the free protons [204] will be captured in the vital fluids (plasma or cytoplasm) and these are of interest. The process of catalytically converting protons [204] into water using a catalyst [201] and oxygen [205] while producing a voltage and a current is a commonplace cathode reaction in a fuel cell and although there are additional chemicals and products present, the process still works.

If a scavenging implant [215] is made with one catalytic electrode [201] and a complementary electrode [202] and connected to a circuit [203] it is possible to implant the scavenging implant [215] into the tissue of an organism (not shown) and sequestrate a permanent source of protons [204] and oxygen [205] from the vital fluid (blood) [212] to provide bias for the circuit [203] as long as the organism (not shown) continues to live.

The scavenging implant [215] is thus able to sequestrate energy from the host and thereby to power a circuit [203] with that energy. The apparatus uses the vital fluid [210] or [212] in the organism as an electrolyte and collects a monolayer of dissociated oxygen molecules [208] which compete with the host to collect protons [204] that it uses to draw electrons from the conduction band of the catalytic electrode [201]. The catalytic electrode [201] assumes a negative potential with respect to the complementary electrode [202] and supplies power to its circuit.

The half-cell [200] does not require an independent source of fuel but does produce energy using oxygen [205] and protons [204] taken from the organism (not shown). This is similar to a half-cell (not shown) being supplied with a proton-rich fluid (not shown) but in this case the half-cell [201], [202] is located internal to the source of ions which power it. In biological terms it becomes a parasite or if the circuit [203] provides a benefit to the host such as a pacemaker function (not shown) it becomes a symbiotic appliance.

Example Detector of a Proton-Aura from a Living Organism

The process of reducing NAD to NADH produces free protons which tend to be captured by other processes in living matter. Some free protons tend to escape and radiate into the environment. If male bufo bufo in an excited state can sense excess protons before an earthquake it implies that their “mating mode” is somehow influenced by density of protons (increase or decrease). The researchers did not find to where the males went but all of them chose to be elsewhere. It is reasonable that they may have been pursuing the great attraction of where the protons were originating (miles from where the researchers were) or they fled as the researchers assumed. In this case it appears that specific bufo bufo can sense the presence of a proton-aura. Another explanation could be that bufo bufo may have acquired their sensitivity as part of detecting large predators (against whom they have little defense) and the great increase in proton-aura concentration corresponded to a charging elephant times 100.

Pursuing this line of thinking, there are anecdotal reports that masters of religious orders have taught that there are auras radiating from people, trees, leaves and animals that they are able to see. Although this has been challenged as unproven, it remains possible that some people have trained themselves to “sense” as well as the bufo bufo. No reports have been found of the behavior of religious masters before earthquakes. The occult term “aura” is not to be confused with the term “proton-aura” although there may be some commonality.

Proton-auras are ordinary chemical forms and they are known to occur when the sun emits large gas eruptions, it is tenable that living things may radiate them but science has had little consensus about detecting and explaining them so they are seldom documented and remain somewhat uncertain. This statement applies to thermal neutron-auras except that uranium²³⁵ and plutonium can detect them in ways (i.e. they promote fission). Electron-auras have been well studied in communication, RADAR and power transmission.

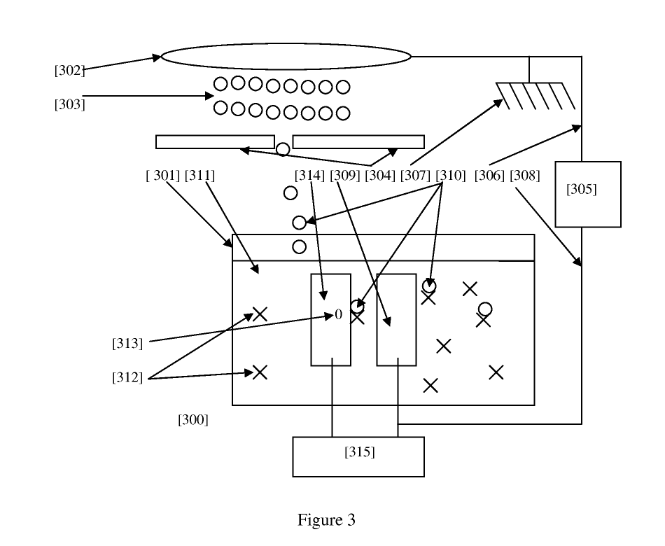

FIG. 3 is a simplified illustration of a proton-aura detection system [300] with field enhancement. Enhanced scanning proton detection system [300] is shown as half-cell [301], with living organism [302], emitting a proton-aura [303], through movable scanning aperture [304], with a bias potential source [305], whose positive terminal [306] is connected to the living organism [302] as well as to earth [307], and whose negative terminal [308] is connected to the complementary electrode [309], such that protons [310] passing through scanning aperture [304] are attracted to the electrolyte [311] and ride on acid cores [312] until they react with dissociated oxygen atoms [313] on the catalytic electrode [314] and draw electrons from the catalyst's conduction band (not shown), the circuit is completed by the complementary electrode [309] through the external circuit [315].

Proton detectors can be used to detect the presence of living matter and to map the locations of animals or plants. Whereas there are limitations to mapping with infra-red because it can be shielded, attenuated, reflected or imitated, there is a completely different set of constraints on proton gases. One example is that they can go around a direct blockage by diffusion or engulfment and tend to decay away over a lengthy but indefinite period after they are introduced.

### An Example of a Proton-Aura Source

Proton-auras can be produced in various ways such as through a proton-permeable window or ionizing a stream of hydrogen at high temperatures.

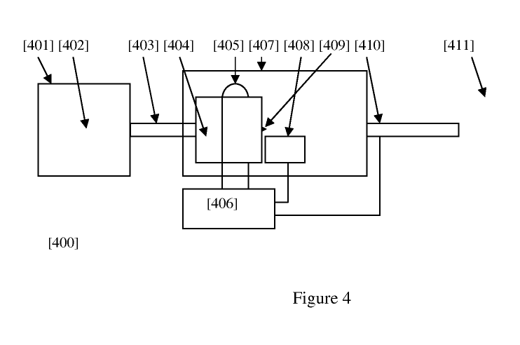

FIG. 4 is a simplified drawing of a proton-aura generating system [400], hydrogen source tank [401] containing hydrogen gas [402] flowing through tube [403] into heating chamber [404], heater [405] power source [406] stripping chamber [407], positive stripper plate [408].

If hydrogen gas [402] is heated [404], electrical heater the plasma begins to dissociate into electrons and protons and passes through the orifice [409] the electrons are acquired by the stripper plate [408] after the temperature is lowered in the stripping chamber [407] the proton-aura is pushed through the positively charged conductive tube [410] where it continues to cool and any available electrons are captured by the tube. The necessary step is dissociating the electron from the hydrogen atom and cooling the plasma, after which the electrons may be returned without reaction (not shown). Because hydrogen ions are positively charged particles, they resist being tightly compressed, for some purposes it is possible to have electrons mixed with the protons and have no reaction. It is noted that the electrons and protons are in such an arrangement in deep space where there are very few per cubic meter. Plasma consisting of protons without electrons at low temperature (not shown) is stable.

Due to the light weight of thermal protons, their average velocity at any temperature is high. Because of their monatomic structure, they have few quantum mechanical degrees of freedom, and their specific heat is correspondingly low.

When deuterium or tritium is used to replace hydrogen in these processes it is possible to produce proton-auras with one or two neutrons bonded to each proton. These have different thermal velocities and behaviors. The natural occurrence of deuterium is 0.015% and tritium is very low (tritium has a half-life of 12.26 years) and therefore it is possible to use proton auras with different percentages of the three isotopes and then distinguish the manner in which they entered into reactions.

### An Example of a Proton-Aura Circuit Through Air

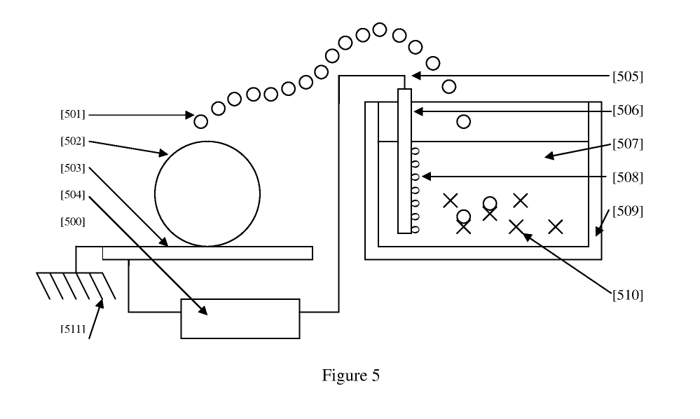

FIG. 5 [500] shows protons [501] emanating from an animal [502] such as a mouse or a lion which is powered by food (not shown) such as corn or sheep (not shown). The animal is standing on a metallic surface [503] which is connected a neutral potential such as earth ground [511], and to external electrical contact [505] through external circuit [504] to a catalytic electrode [506]. As the protons [501] reach the electrolyte [507] contained in substrate [509] they are hosted by acid cores [510] and ride the thermal motions until they reach an oxygen atom dissociated on the surface of the catalyst [508] which then draws an electron from the conduction band of the catalyst (not shown) and forms an OH⁻ ion (not shown) that remains on the catalytic surface. A second proton will complete the reaction, forming a water molecule (not shown) and drawing a second electron. The electrons are passed through the external connection [505] back to the metallic surface [503] and to the animal or the neutral potential, thus neutralizing the charge created by the emission of the proton. This allows electrical power to be produced in various useful locations.

### An Example of a Proton-Aura Circuit Predicting an Earthquake

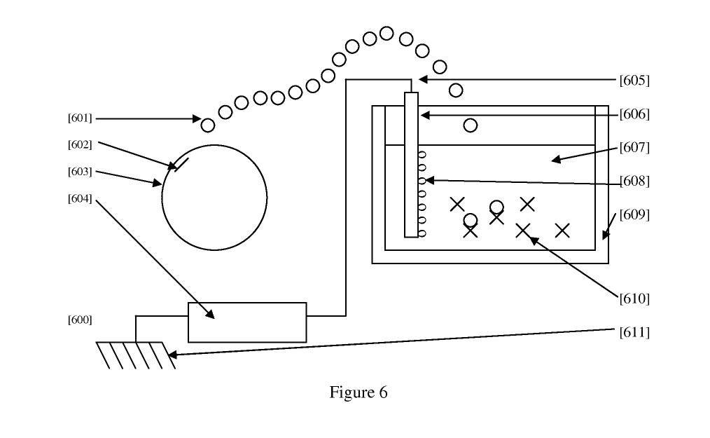

FIG. 6 [600] shows protons [601] emanating from a fault [602] such as the San Andreas on the earth [603] prior to an earthquake (not shown), which is powered by diastrophism (not shown) involving tectonic plates (not shown). The neutral potential earth ground [611] is connected to external connection [605] through external circuit [604] to a catalytic electrode [606]. As the protons [601] reach the electrolyte [607] contained in substrate [609] they mount acid cores [610] and ride the thermal motions until they reach an oxygen atom dissociated on the surface of the catalyst [608] which then draws an electron (not shown) from the conduction band of the catalyst (not shown) and forms an OH⁻ ion (not shown) that remains on the catalytic surface. A second proton will complete the reaction, forming a water molecule (not shown) and drawing a second electron (not shown). The electrons are passed through the external connection [605] back to the metallic surface [604] and drawn from the earth [603], thus neutralizing the charge created by the emission of the protons. The protons were released by the final phase as the material along the fault reaches its stress limit and begins to crush. Initially there is a plastic deformation and the release of protons. At this time the crushing material becomes stronger. The small motion that was involved in crushing the fault puts a momentum into the surrounding rock. As the strengthening occurs the momentum will produce a peak force. The time of the peak force is when the earthquake is most likely to occur.

Because protons are poorly absorbed by the rocks they move through the most permeable materials available. This is usually the existing fault and many will reach the surface. As the number of protons increases the current through the external circuit will increase. This allows an electrical signal to be produced in a detector before the most probable time for an earthquake to occur.

### An Example of a Direct Proton Capture Cell Making Hydrogen

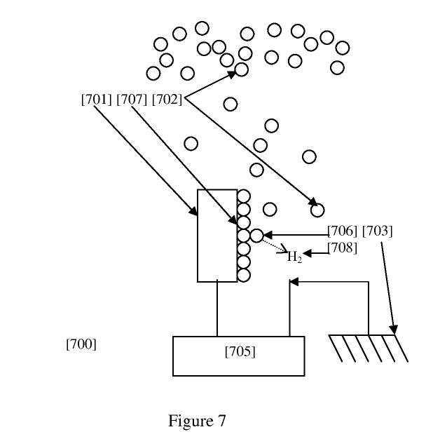

FIG. 7 is a simplified illustration of a direct proton capture cell [700]. Capture electrode [701], an environment of protons [702], neutral potential earth ground [703], external circuit [705], a proton [706] striking another proton in a layer of protons [707] resulting in a hydrogen molecule [708].

The capture cell [700] catalytic electrode [701] has a surface (such as graphene, carbon nanotubes or graphite) that forms a covalent bond to protons. When a proton [702] encounters such a surface it immediately forms a covalent bond which does not require the exchange of electrons and is weakly stable. The incident protons tend to form a layer over the surface of the electrode. The positive charge of the proton draws one unit of electronic charge (one electron) through external circuit [705] if it is available. If this proton is struck by another proton with at least a threshold amount of energy the two protons will draw out two electrons which will spin-couple and form a hydrogen molecule [708]. The new molecule will be neutral and also will have no affinity to the carbon surface. It leaves the graphene with a positive charge.

Because it does not depend on the presence of oxygen to produce power and can produce confined hydrogen under pressure, this configuration has the potential to be useful in where there are protons and electrons but no source of pressurized gas. Although the particle density and temperature may be low, travelling at 1 million meters per second with a one square meter collector will sweep a volume of 1 million cubic meters per second. The particles will have a high apparent temperature.

The capture electrode [701], to which colliding protons [702] tend to stick via a covalent bond. The neutral potential earth ground [703] acts as the complementary electrode. Because the protons have a positive charge, an electron from the conduction band (not shown) is drawn into a covalent bond and the surface accumulates a layer of protons [707]. When an additional proton [706] collides with one of the protons on the surface, another electron (not shown) is drawn from the conduction band of the catalyst and results in a hydrogen molecule [708]. The circuit is completed by the earth electrode [703] through the external circuit [705]. The formation energy of the hydrogen molecule contributes a potential which yields a positive net output voltage from the cell.

### An Example of a Direct Proton Capture Cell Making Water

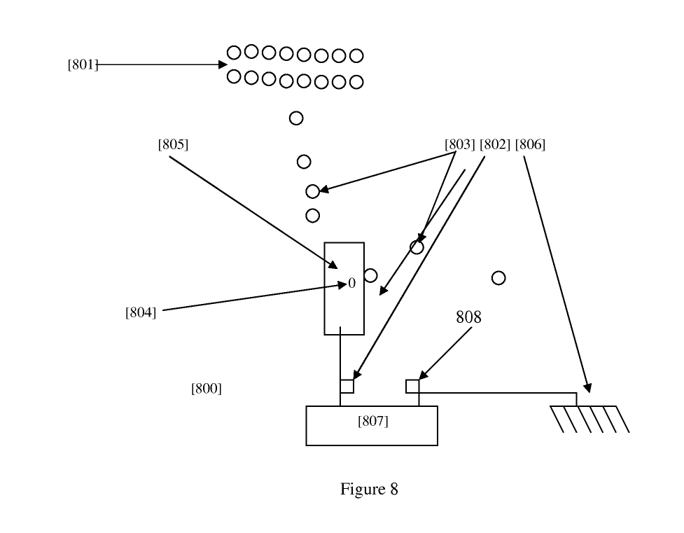

FIG. 8 is a simplified illustration of a proton detection system [800], a proton-aura [801], the system positive terminal [802], protons [803], dissociated oxygen atoms [804] on the catalytic electrode [805], the ground electrode [806], the external circuit [807], the system negative electrode [808].

In this half-cell protons [803] react with dissociated oxygen atoms [804] on the catalytic electrode [805] and draw electrons (not shown) from the catalyst's conduction band (not shown) producing water (not shown). The circuit is completed through external circuit [807] by the ground electrode [806] which is connected to the negative electrode [808].

An Example of a Proton Oxidization Cell with Movable Media

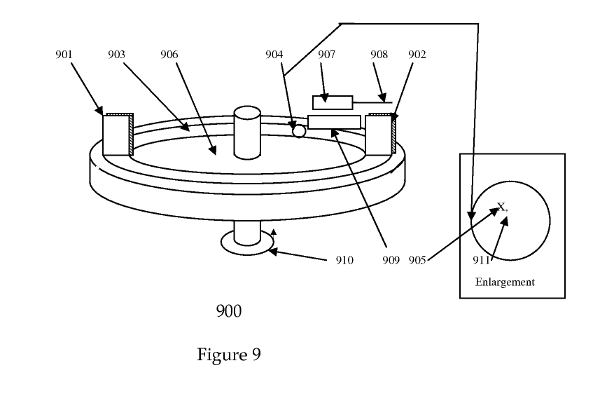

FIG. 9 is a simplified illustration of an electromechanical system 900. Fuel cell system 900 includes a first electrode 901, an ion-hosting fluid which may be a colloid 903, an ion or colloid particle 904, a site wherein an ion may reside 905, rotating table 906, a gate electrode 907, an independent electrical potential 908, a gate insulator 909, and mechanical input 910, an ion residing in a site (911). FIG. 9 is a larger system view similar to FIG. 1 in that each may contain ions (or colloids to hold charged ions) to move the ions. In FIG. 9 the ions are transported from first electrode 901 to the second electrode 902.

As was true of the discussion of FIG. 1, even though the structures are different in some respects, they are identical in one respect, namely that the medium flows from one region to another under some type of influence. In FIG. 9 the potential of the gate electrode may influence the operation of the cell and there is provision (910) to rotate the table (906) which may also adjust the speed of the table. Of course there will be energy interchanged with the mechanical input (910) due to the integral of the electrostatic force and the distance over which it acts.

It should be understood that a countering consideration is posed by the rule that no field can exist within a conductor. This rule is perfectly-enforced within a superconductor, very well-enforced within highly conductive metals, fairly well-enforced in ionic solutions and poorly-enforced within semiconductors. In this sense, de-ionized water at 70 degrees Fahrenheit and 20 Meg Ohm-Cm is a fair semiconductor. As H₂SO₄ is added to de-ionized water the resistance drops rapidly and must be compensated by changes in the aspect ratio of the geometry during design. The water may be replaced by non-conducting fluids with a colloidal suspension of silica gel spheres wetted with water and sulfuric acid or nano-particles such as Buckey balls filled with acid and water. The fluid can be a liquid, gas, plastic solid, plasma or grains of solid particles such as sand or resin. As each replacement is made the properties of the fluid become different. Again, the transport table can be a nanostructure such as a gear-shaped molecule with ion-binding cores such as SO4-2 ions on the teeth. A design engineer familiar with the art can understand the necessary structures. Although much of the theory discussed here is described in the macro level there are nano-scale equivalents in which the usefulness of the devices is quite high. In these cases there is sometimes a blending of the features of FIG. 17 and FIG. 18.

### Examples of Proton-Aura Applications

These isolated systems will interact with electrostatic and magnetic fields to produce devices similar to magnetrons and vacuum tubes.

Similar technologies can be used to produce intense proton-auras, which can be used to study how various species react to them.

Proton-auras can feed populations of carrier sites, such as acid cores and colloidal mediums which may be suspended in water or other fluid. If the fluid is a semiconductor or an insulator, the carriers may be field controlled and act as gates and amplifiers.

The proton-auras may also be used to: make lighter than air devices, power fuel cells, study animal responses, train people how to detect proton fields.

Living organisms have a diverse variety of chemicals and many interactive sites. Living organisms produce free protons and also collect many of the free protons that they produce. When an organism is in a concentrated proton-aura there will be a net flow of protons into the organism until the organism reaches equilibrium with the density of the proton-aura. After equilibrium is reached, if the organism is still producing free protons there may again be an outward flow of proton-aura. Because the organism is collecting many protons and these protons are a significant source of the energy that powers the organism, it is arguable that some organisms will be able to derive a portion of the energy that they require directly from an intense proton-aura. Such a proton-aura can provide an alternate source of energy for life forms, and provide a resource for biological and medical research. It is possible that life forms may be able to operate for extended periods, subsisting on water, protons and trace amounts of minerals and nutrients. Bacteria that derive their energy from radiation have been found miles below the surface of the earth.

In the case of other animals (particularly insects and spiders), that can maintain their fluids for long periods without eating, a powerful proton-aura can be a way to alternatively power them to be active and not feel hungry. Other than putting bufo bufo into flight mode, a proton-aura should be a defense against other, more dangerous animals including interrupting the mating of cane toads or making fire ants want to search elsewhere.

If female mosquitoes stop biting before an earthquake, the ramifications of the use of proton-auras to alter their behavior can have a compelling value. Aside from being an argument for moving to some geo-active places such as are available in California, it may be considered good if a female mosquito loses her appetite at times that people may choose. Being able to bathe a picnic area with a proton-aura may be beneficial. Similarly it is good for a spider to not feel hungry at an inconvenient time. Bedbugs have been found to carry MRSA (Methicillin-resistant Staphylococcus aureus) and it has become a concern. Making bedbugs lose their appetite for a few days after being exposed to a proton-aura may be helpful. Travelers can expose their accommodations to a proton-aura before retiring to discourage bites by the local population.

In particular, many animals have been reported to be restless and fearful before an earthquake. The proton-aura source is a tool to better learn the responses of animals and perhaps change some of the less desirable behaviors.

### Examples of Proton-Aura Electrical Effects

Protons in air behave more like atoms than like electrons (whose mass is 1/1837 as much and travel more than 42 times as fast at equal energies). Protons weigh half as much, and thermally travel twice as fast, as hydrogen. They represent a fraction of the make-up of air and that portion depends on the presence of living matter, fault stress and thunderheads or tornados.

### Example of Proton-Aura Effects on Weather

One source of protons is living things. Consider the case of cornfields and alfalfa sprouting in spring. A blanket of protons is released over many miles and a response in the ionosphere is a lot of electrons gathering overhead. The natural response to the field is thunderheads. When a bubble of protons forms in response, there is a tendency for the thunderhead to swoop down and be a tornado.

What is claimed:

1. An electrochemical cell system comprising:
a at least one first electrode able to support a flow of ions and having a first external electrical contact;
a non-conducting substrate having at least one opening;
at least one medium comprising ion-hosting sites, wherein the at least one opening comprises the at least one medium comprising ion-hosting sites and the first electrode, wherein the at least one medium is the same or different among the at least one substrate opening;
a second electrode able to conduct electrons between the at least one medium and a second external electrical contact, wherein the at least one opening comprises the at least one medium comprising ion-hosting sites and the second electrode;
an apparatus configured to move the at least one medium, wherein the at least one medium is moved between the at least one first electrode and the at least one second electrode;
wherein: electrons flow between the first external electrical contact and the second external electrical contact through an external circuit, and
ions flow between the at least one first electrode and the ion-hosting sites in the at least one medium, and
electrons flow between the second electrode and the at least one medium.

2. An electrochemical half-cell system comprising:
a first electrode with a catalytic surface and having a first external electrical contact;
at least one medium comprising proton-hosting sites able to capture a portion of environmental protons;
an area of the at least one medium comprising proton-hosting sites exposed to environmental protons;
an oxygen layer on the catalytic surface of the first electrode able to oxidize hosted protons and draw electrons from the conduction band of the catalyst;
a second electrode able to conduct electrons between the at least one medium and a second external electrical contact;
wherein: protons flow between the catalytic surface of the first electrode and the proton-hosting sites in the at least one medium comprising proton-hosting sites, and
electrons flow between the conduction band of the catalyst and the external electrical contact of the first electrode, and
electrical charge flows between the second electrode external electrical contact and the at least one medium, and
electrons flow between the first external electrical contact and the second external electrical contact through an external circuit influenced by the portion of the environmental protons.

3. The electrochemical half-cell system of claim 2 wherein the source of free protons is influenced by geological fracture stress thereby influencing the flow of electrons through the external circuit.

4. The electrochemical half-cell system of claim 2 wherein the source of free protons is influenced by volcanic activity thereby influencing the flow of electrons through the external circuit.

5. The electrochemical half-cell system of claim 2 wherein the source of free protons is influenced by weather conditions thereby influencing the flow of electrons through the external circuit.

6. The electrochemical half-cell system of claim 2 wherein the source of free protons is influenced by agricultural growth thereby influencing the flow of electrons through the external circuit.

7. The electrochemical half-cell system of claim 2 wherein the source of free protons is influenced by animal life thereby influencing the flow of electrons through the external circuit.

8. The electrochemical half-cell system of claim 2 wherein the source of free protons is influenced by solar activity thereby influencing the flow of electrons through the external circuit.

9. The electrochemical half-cell system of claim 2 wherein the source of free protons is influenced by conditions outside the atmosphere of earth thereby influencing the flow of electrons through the external circuit.

10. The electrochemical half-cell system of claim 2 wherein the flow of electrons through the external circuit provides information to digital systems to assess and predict the environment.

11. A half-cell comprising:
a first electrode having a catalytic surface and a first external electrical contact;
vital fluid of a living organism engulfing the electrodes;
oxygen from the vital fluid dissociates onto the catalytic surface of the first electrode;
protons from the vital fluid oxidize at the catalytic surface of the first electrode;
a second electrode able to conduct electrons between the vital fluid and a second external electrical contact;
wherein: electrons flow between the first external electrical contact and the dissociated oxygen on the catalytic surface of the first electrode;
protons flow between the vital fluid and the dissociated oxygen on the catalytic surface of the first electrode;
electrons flow between the vital fluid and the second electrode external electrical contact
electrons flow between the first external electrical contact and the second external electrical contact through an external circuit.

12. A direct proton capture half-cell comprising:
an electrode able to bond protons to its surface and having an external electrical contact;
at least one proton bonded to the surface of the electrode;
at least one free environmental proton moving toward one of the bonded protons with enough energy to overcome electrostatic forces;
a connection of the external contact through an external circuit to a neutral potential;
wherein: protons strike the protons bonded to the surface of the electrode, and
electrons flow between the external electrical contact and the layer of protons bonded to the surface of the electrode, and
hydrogen molecules flow away from the electrode surface.
electrons flow between the external electrical contact and the neutral potential through the external electrical circuit at a rate that is influenced by the number of environmental protons striking protons bonded to the surface of the electrode.

13. The direct proton-capture half-cell of claim 12 wherein the flow of electrons through the external circuit provides information to digital systems to assess and predict geological events.

14. The direct proton-capture half-cell of claim 12 wherein the flow of electrons through the external circuit provides information to digital systems to assess weather conditions.

15. A direct proton-capture half-cell comprising:
an electrode with a catalytic surface able to dissociate oxygen on its surface and having an external electrical contact;
a layer of dissociated oxygen atoms on the surface of the electrode;
at least one free environmental proton moving toward one of the dissociated oxygen atoms;
a connection through an external circuit to a neutral potential;
wherein: free environmental protons strike the layer of dissociated oxygen atoms on the surface of the first electrode, and
electrons flow between the external electrical contact and the layer of dissociated oxygen atoms on the surface of the electrode, and
water molecules are formed on the electrode surface, and
electrons flow between the external electrical contact and the neutral potential through the external electrical circuit at a rate influenced by the number of free environmental protons.

16. The direct proton-capture half-cell of claim 15 wherein the flow of electrons through the external circuit provides information to digital systems to assess and predict geological events.

17. The direct proton-capture half-cell of claim 15 wherein the flow of electrons through the external circuit provides information to digital systems to assess weather conditions.

18. The electrochemical cell system of claim 1 further comprising an at least one gate electrode and a gate insulator wherein an independent electrical potential on the gate electrode can influence the output of the cell.

19. The electrochemical cell system of claim 1 further comprising a mechanical input able to move the medium, exchanging energy with the ions in the medium and influencing the output of the cell.

20. The electrochemical cell system of claim 1 wherein the medium consists of non-conducting fluid with an ionic colloidal suspension.
